(19) United States
(12) Patent Application Publication
(10) Pub. No.: US 2004/0263701 A1
(43) Pub. Date: Dec. 30, 2004

(54) Electrophoretic display apparatus

(76) Inventor: Nobutaka Ukigaya, Chigasaki-shi (JP)

Correspondence Address: MORGAN & FINNEGAN, L.L.P., 3 WORLD FINANCIAL CENTER, NEW YORK, NY, 10281-2101, US

(21) Appl. No.: 10/827,850

(22) Filed: Apr. 20, 2004

(30) Foreign Application Priority Data
Apr. 21, 2003 (JP) 115717/2003(PAT.)

(51) Int. Cl. G02F 1/133

(52) U.S. Cl. 349/36

(57) ABSTRACT

An electrophoretic display apparatus includes a pair of substrates disposed opposite to each other, charged particles and an insulating liquid which are disposed in a spacing between the pair of substrates, a pair of electrodes for driving the charged particles, and drive means for applying to one of the pair of electrodes, a voltage for moving the charged particles, and applying to the other electrode, an AC voltage biased with a DC component. The AC voltage applied to the other electrode has a frequency which is higher than an upper limit of a frequency causing movement of the charged-particles and is lower than an upper limit of a frequency causing movement of ions contained in the insulating liquid. The ions do not remain on the surface of the substrate for a long time, thus causing no residual DC voltage.

### FIELD OF THE INVENTION AND RELATED ART

The present invention relates to an electrophoretic display apparatus, particularly an electrophoretic display apparatus using TFTs (thin film transistors) as switching elements.

A conventional electrophoretic display apparatus is accompanied with an occurrence of an afterimage of a display pattern to deteriorate a display characteristic.

More specifically, a center of a pixel electric potential varies depending on a display gradation level, so that when a gradation pattern other than a halftone is displayed, a DC component is substantially applied to an electrophoretic display cell in an area of the gradation pattern. As a result, ions in the electrophoretic display cell or an interface between insulating layers forms an electric double layer to create an inner electric potential. In this case, the DC component remains and an effective voltage is changed in the gradation pattern, whereby a difference in luminance is caused to occur in some cases even when an identical electric potential is applied to different pixels. As another problem, when a display state is continuously retained for a long time under application of a voltage of 0 V to a pixel electrode so as to provide a memory state without switching a display state, such a phenomenon that charged particles (electrophoretic particles) are fixed onto an insulating film is caused to occur. This may also be attributable to the above-described creation of inner electric potential through formation of electric double layer by ions or insulating layer interface. As a result, in the case of writing after a long term memory state, there arises such a problem that a desired luminance cannot be attained by the influence of a previous display state.

### SUMMARY OF THE INVENTION

An object of the present invention is to provide an electrophoretic display apparatus having solved the above described problems.

According to the present invention, there is provided an electrophoretic display apparatus, comprising:

a pair of substrates disposed opposite to each other,

charged particles and an insulating liquid which are disposed in a spacing between the pair of substrates,

a pair of electrodes for driving the charged particles, and

drive means for applying to one of the pair of electrodes, a voltage for moving the charged particles, and applying to the other electrode, an AC voltage biased with a DC component for moving the charged particles,

wherein the AC voltage applied to the other electrode has a frequency which Is higher than an upper limit of a frequency causing movement of the charged particles and is lower than an upper limit of a frequency causing movement of ions contained in the insulating liquid.

In the electrophoretic display apparatus of the present invention, an electric potential or polarity of a pixel electrode is inverted at high speed, whereby it is possible to suppress an electric double layer due to residual ions or polarization of an insulating film in an electrophoretic cell. As a result, it becomes possible to achieve an effect of reducing an occurrence of afterimage.

This and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of an embodiment of an electrophoretic display apparatus according to the present invention.

FIG. 2 is a schematic waveform chart of an applied voltage in the embodiment of the present invention.

FIG. 3 is a block diagram showing a structure of the electrophoretic display apparatus according to the present invention.

FIG. 4 is a schematic sectional view of another embodiment of an electrophoretic display apparatus according to the present invention.

FIG. 5 is a schematic waveform chart of a voltage applied to a common electrode in another embodiment of the present invention.

### DESCRIPTION OF THE PREFERRED EMBODIMENTS

(Embodiment 1)

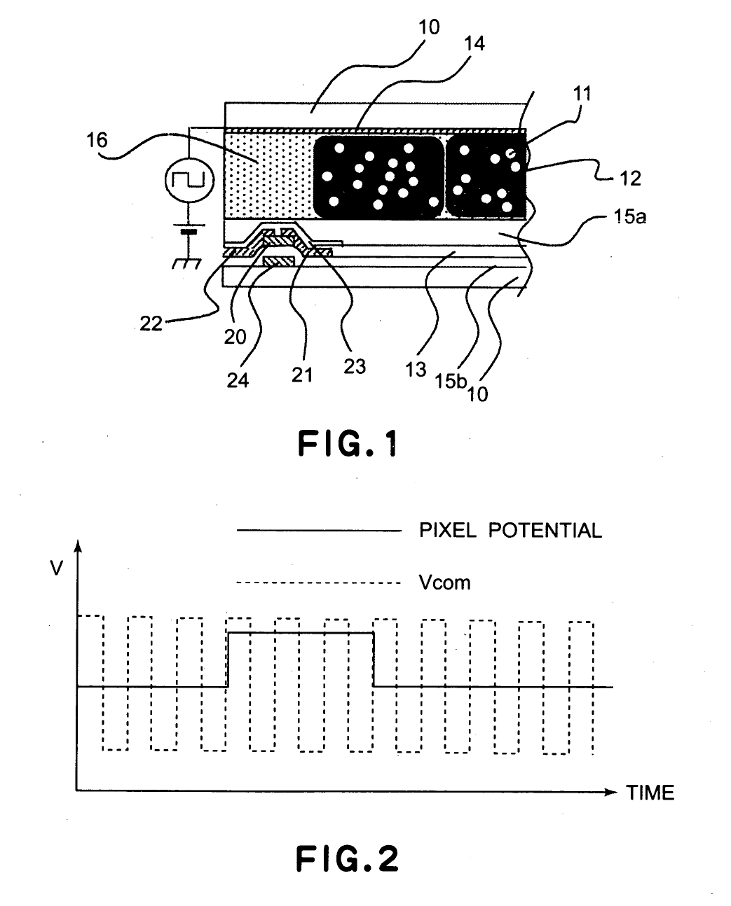

This embodiment will be described with reference to FIGS. 1, 2 and 3.

FIG. 1 schematically illustrates a cross section of the electrophoretic display apparatus of the present invention.

Referring to FIG. 1, the electrophoretic display apparatus includes a pair of substrates 10, charged particles (electrophoretic particles) 11, an insulating liquid 12, a pixel electrode 13, a charged particle 14, and an insulating layer 15a. The insulating layer 15a is disposed to cover the pixel electrode 13 in order to prevent loss of electric charges by direct contact of the charged particles 11 with the pixel electrode 13, but may also be disposed on the common electrode 14.

The electrophoretic display apparatus further includes a gate insulating layer 15b which extends also under the pixel electrode 13, a spacer 16, an amorphous silicon film 20, a drain electrode 21, a source electrode 22, a passivation film 23, and a gate electrode 24.

FIG. 2 shows a drive voltage waveform used in this embodiment. Referring to FIG. 2, a pixel electric potential applied to the pixel electrode 13 is indicated by a solid line, and a potential (Vcom) applied to the common electrode 14 is indicated by a dotted line. In the electrophoretic display apparatus of this embodiment, a voltage applied to the common electrode 14 comprises a DC voltage biased or superposed with an AC voltage.

A frequency of the AC voltage for the common electrode 14 is set in such a range that polarization of ions or the like contained in the insulating liquid 12 can follow the frequency but the charged particles cannot follow the frequency. More specifically, the frequency is set in the range of several kHz to several tens kHz.

On the other hand, an electric potential of the common electrode 14 is given by applying a voltage pulse having a large amplitude and a long pulse width to the extent that the charged particles 11 can be moved. In many cases, the pulse width may suitably be in the range of 10 ms to 100 ms.

In this embodiment, the amplitude of the AC voltage for the common electrode 14 is increased to such an extent that a polarity of a voltage actually applied to a pixel is inverted. More specifically, the amplitude is set to be larger than the voltage of pixel electrode 13, i.e., a maximum of an amplitude of the drain voltage. By doing so, the ions more even in a period in which the pixel electrode potential is applied, so that it is possible to always create such a state that a residual DC voltage is not caused to occur.

A DC component of the common electrode potential, i.e., a center value of the common electrode potential is set to be coincident with a center value of a range of a signal potential applied to the pixel electrode 13 for image display.

By setting the both electrode potentials at the pixel as described above, it becomes possible to realize an environment of no uneven ion distribution, i.e., no occurrence of the residual DC voltage. On the other hand, in such an environment, the charged particles can migrate, thus providing a desired display state.

In the case where the residual DC voltage is caused not by the movement of ions in the insulating liquid 12 but by charge transfer in the insulating layer 15a, the voltage and frequency of the AC voltage described above is required to be such an extent that the AC voltage has an amplitude causing charge transfer in the insulating layer 15a and a high frequency which does not cause movement of the charged particles.

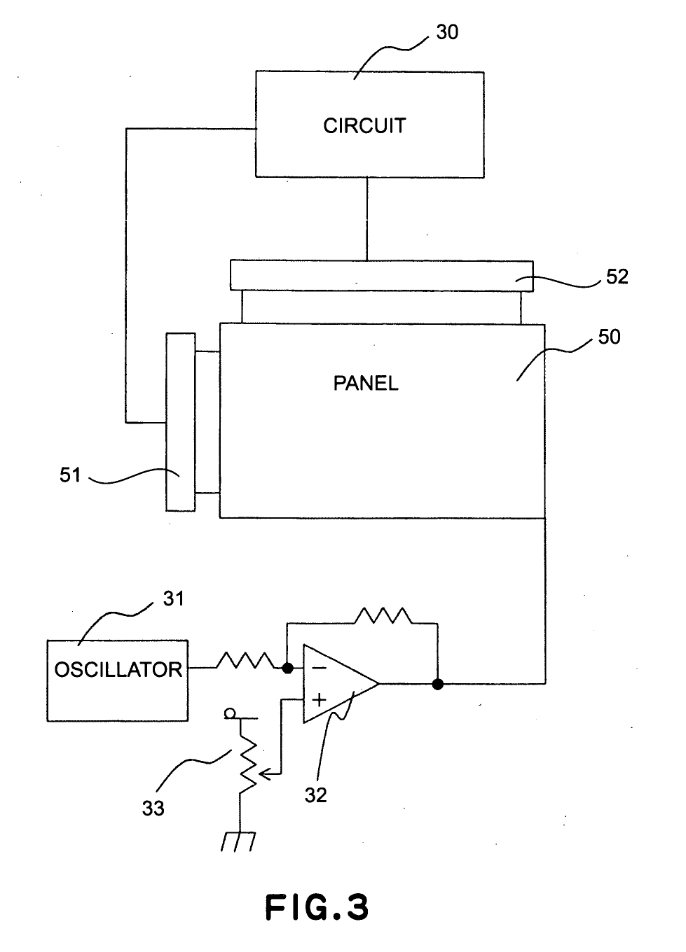

FIG. 3 is a block diagram showing a drive circuit in this embodiment. Referring to FIG. 3, the drive circuit includes a signal processing circuit 30, a crystal oscillator 31, an operational amplifier (opamp) 32, a voltage offset circuit (variable resistor) 33, and an electrophoretic display panel 50. Along the electrophoretic display panel 50, a scanning line driver 51 and a signal line driver 52 for applying voltages to the gate electrode 24 and source electrode 21, respectively, of TFT shown in FIG. 1, are disposed. The signal processing circuit 30 is a control circuit for effecting a matrix drive by transmitting signals to these drivers.

The circuits 31, 32 and 33 shown in FIG. 3 constitute a voltage application circuit for applying a voltage to the common electrode 14 in FIG. 1.

An oscillating (vibration) signal from the crystal oscillator 31 capable of effecting a high-frequency oscillation on the order of kHz is inputted into an inversion input terminal of the operational amplifier 32 and after being amplified, is inputted into the common electrode 14 of the display panel 50. A wiring between the operational amplifier 32 and the display panel 50 is connected to the common electrode 14 of the electrophoretic display apparatus shown in FIG. 1. The other input terminal of the operational amplifier 32 is connected to the variable resistor 33 to adjust a value of the variable resistor 33 so that a center value of the common electrode potential is coincident with a center value of the pixel electrode potential.

By setting the common electrode potential as described above, it is possible to alleviate such a phenomenon that an effective DC component is identical with time but a polarity is frequently inverted with time, thereby to fix the residual ions or polarization in the insulating layer. Further, the charged particles do not follow the frequency and thus do not adversely affect resultant image qualities.

(Embodiment 2)

This embodiment will be described with reference to FIGS. 3, 4 and 5.

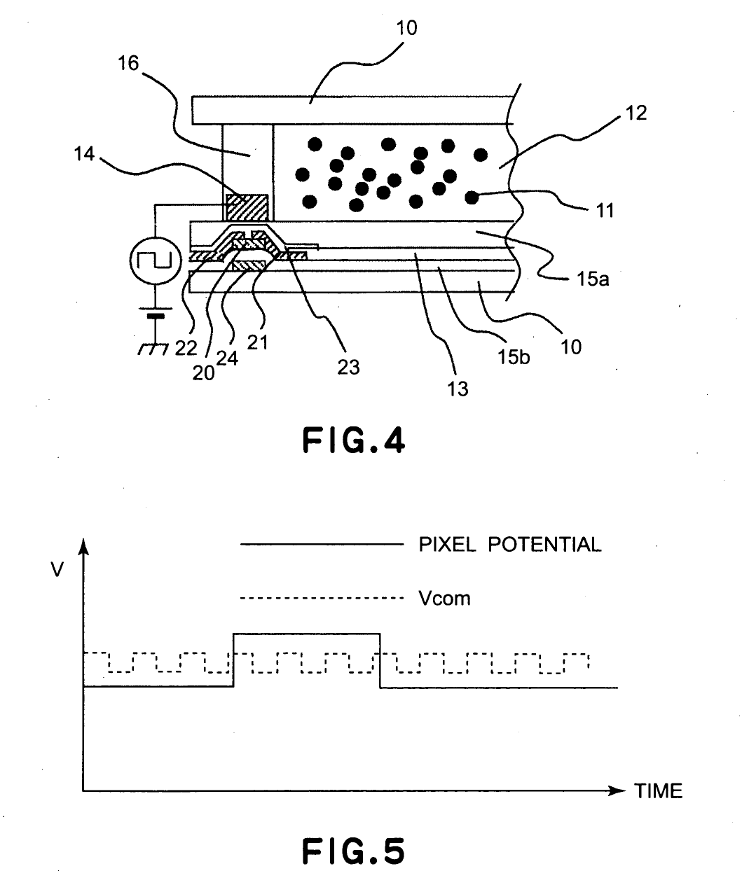

FIG. 4 shows a cross section of an electrophoretic display apparatus in this embodiment. The electrophoretic display apparatus has the same structure as that of Embodiment 1 (FIG. 1) except that the common electrode 14 is not disposed on the upper substrate 10 but is disposed under the spacer 16.

FIG. 5 shows a drive voltage waveform used in this embodiment. Referring to FIG. 5, a pixel electric potential applied to the pixel electrode 13 is indicated by a solid line, and a potential (Vcom) applied to the common electrode 14 is indicated by a dotted line, similarly as in FIG. 2. Also in the electrophoretic display apparatus of this embodiment, a voltage applied to the common electrode 14 comprises a DC voltage biased or superposed with an AC voltage. A DC component of the common electrode potential, i.e., a center value of the common electrode potential is set to be coincident with a center value of a range of a signal potential applied to the pixel electrode 13 for image display.

In this embodiment, similarly as in Embodiment 1, a frequency of the AC voltage for the common electrode 14 is set in such a range that polarization of ions or the like contained in the insulating liquid 12 can follow the frequency but the charged particles cannot follow the frequency. More specifically, the frequency is set in the range of several kHz to several tens kHz.

On the other hand, an electric potential of the common electrode 14 is given by applying a voltage pulse having a large amplitude and a long pulse width to the extent that the charged particles 11 can be moved. In many cases, the pulse width may suitably be in the range of 10 ms to 100 ms.

In this embodiment, however, the amplitude of the AC voltage for the common electrode 14 is set to be smaller than a maximum of an amplitude of the drain voltage. By doing so, the ions more even in a period in which the pixel electrode potential is 0 V for a long time, so that it is possible to always create such a state that a residual DC voltage is not caused to occur. Further, the amplitude is smaller than that in Embodiment 1, so that it is possible to reduce power consumption during the AC voltage application to a low level.

The circuit for applying the AC voltage to the common electrode is identical to that shown in FIG. 1 used in Embodiment 1.

By setting the common electrode potential as described above, it is possible to alleviate such a phenomenon that an effective DC component is identical with time but a polarity is frequently inverted with time, thereby to fix the residual ions or polarization in the insulating layer. Further, the charged particles do not follow the frequency and thus do not adversely affect resultant image qualities.

What is claimed is:

1. An electrophoretic display apparatus, comprising:
a pair of substrates disposed opposite to each other,
charged particles and an Insulating liquid which are disposed in a spacing between the pair of substrates,
a pair of electrodes for driving said charged particles, and
drive means for applying to one of said pair of electrodes, a voltage for moving said charged particles, and applying to the other electrode, an AC voltage biased with a DC component for moving said charged particles,
wherein said AC voltage applied to the other electrode has a frequency which is higher than an upper limit of a frequency causing movement of said charged particles and is lower than an upper limit of a frequency causing movement of ions contained in said insulating liquid.

2. An apparatus according to claim 1, wherein the DC component of the AC voltage is set at a substantially center level of a modulation range of the voltage for moving said charged particles.

3. An apparatus according to claim 1, wherein the AC voltage has an amplitude which is larger than an amplitude of the voltage for moving said charged particles.

4. An apparatus according to claim 1, wherein the AC voltage has an amplitude which is smaller than an amplitude of the voltage for moving said charged particles.

5. An electrophoretic display apparatus, comprising:
a pair of substrates disposed opposite to each other,
charged particles and an insulating liquid which are disposed in a spacing between the pair of substrates,
a pair of electrodes for driving said charged particles,
an insulating layer for covering at least one of said electrodes, and
drive means for applying to one of said pair of electrodes, a voltage for moving said charged particles, and applying to the other electrode, an AC voltage biased with a DC component,
wherein said AC voltage applied to the other electrode has a frequency which is higher than an upper limit of a frequency causing movement of said charged particles and is lower than an upper limit of a frequency causing movement of electric charges contained in said insulating layer for covering said at least one electrode.
